(19) United States
(12) Patent Application Publication
(10) Pub. No.: US 2021/0383423 A1
(43) Pub. Date: Dec. 9, 2021

(54) DISTRIBUTED LEDGER-BASED LOYALTY REWARD POINTS RECONCILIATION PLATFORMS

(71) Applicant: JPMORGAN CHASE BANK, N.A., New York, NY (US)

(72) Inventors: Oliver MARGOLIS, London (GB); Tyrone LOBBAN, London (GB); Aaron MERCURIO, New York, NY (US); Jeffrey E. MILLER, Media, PA (US)

(21) Appl. No.: 17/339,383

(22) Filed: Jun. 4, 2021

Related U.S. Application Data
(60) Provisional application No. 63/034,462, filed on Jun. 4, 2020.

(51) Int. Cl. G06Q 30/02; G06F 16/182

(52) U.S. Cl. CPC G06Q 30/0229; G06Q 30/0233; G06F 16/182

(57) ABSTRACT

Distributed ledger-based loyalty reward points reconciliation platforms are disclosed. Embodiments may include a distributed ledger-supported platform that may enable multiple loyalty points/currencies to be distributed by multiple unaffiliated third-parties (e.g., partner merchants) in a transparent, automated way that facilitates adding loyalty points/miles to end customer loyalty accounts as well as settlement between the program provider and the partner merchant. This may be in exchange for some a fixed or per transaction fee for the program provider. The platform may further facilitate the “burning,” or using, of points by reversing the transaction flow and deducting points from the customer loyalty account.

### RELATED APPLICATIONS

This application claims priority to, and the benefit of, U.S. Provisional Patent Application Ser. No. 63/034,462, filed Jun. 4, 2020, the disclosure of which is hereby incorporated, by reference, in its entirety.

### BACKGROUND OF THE INVENTION

### 1. Field of the Invention

Embodiments generally relate to distributed ledger-based loyalty reward points reconciliation platforms.

### 2. Description of the Related Art

Businesses use loyalty reward programs to incentivize customers to use their channels over competitors by granting rewards, discounts and offers to “loyal customers.” Some businesses partner with external loyalty program providers, such as partner merchants, to leverage the breadth and depth of the incumbent loyalty program and subsequently incentivize prospective and existing customers to transact with them rather than a competitor. For example, rental car companies offer airline miles from an airline loyalty program as an added benefit to using that rental car company.

There are several challenges with the current business-to-business practice of purchasing and allocating points earned and burned between program providers and their partner merchant. For example, when a partnership between a program provider and a partner merchant is established, bespoke bilateral Application Programmable Interfaces (APIs) may be used between parties to enable balance checks and changes. Partner merchants may periodically submit bulk buy/sell order to the program provider for every loyalty point earned/burned through their service; these data files are manually reconciled between the parties, which is time consuming and manual. This delayed reconciliation and settlement impacts the end-customers' ability to utilize their earned points.

In addition, points that have been purchased in bulk but not allocated to customers remain a liability on the program provider's balance sheet; the same residual balances remain latent within the partner merchant's systems and use up working capital.

### SUMMARY OF THE INVENTION

Distributed ledger-based loyalty reward points reconciliation platforms are disclosed. In one embodiment, a system may include: a distributed ledger network comprising a plurality of nodes, each node comprising a computer associated with an entity and a cryptographically-secure distributed ledger storing a plurality of immutable data objects. A first node of the plurality of nodes may be configured to: receive, from a partner merchant, a purchase transaction for a good or service and an identifier for a customer loyalty program account with the partner merchant; identify a normalized loyalty program account identifier associated with the identifier for the customer loyalty program account with the partner merchant; confirm that the normalized loyalty program account identifier is valid; send authorization for the purchase transaction to the partner merchant; receive a signed purchase transaction for the purchase transaction from the partner merchant; write the signed purchase transaction to the cryptographically-secure distributed ledger; receive, from a second node of the plurality of nodes and from a loyalty program provider, a signed publication of the signed purchase transaction; issue loyalty points for the purchase transaction to a partner merchant loyalty account maintained on the cryptographically-secure distributed ledger, wherein the partner merchant may be configured to issue the loyalty points to an account associated with the normalized loyalty program account identifier; send to a third node of the plurality of nodes, instructions to debit a partner merchant cash account for the loyalty points; and send the third node instructions to credit a loyalty program provider cash account for the loyalty points.

In one embodiment, the first node may be further configured to apply a rate to covert the loyalty points to a cash amount.

In one embodiment, the rate may be dynamic.

In one embodiment, the purchase transaction may be received at an e-commerce interface for the partner merchant.

In one embodiment, the first node may identity the normalized loyalty program account identifier using a lookup on the cryptographically-secure distributed ledger.

In one embodiment, the immutable data objects may include a balance for the customer loyalty program account, the partner merchant loyalty account, and a loyalty program provider loyalty account.

According to another embodiment, a system may include: a distributed ledger network comprising a plurality of nodes, each node comprising a computer associated with an entity and a cryptographically-secure distributed ledger storing a plurality of immutable data objects. A first node of the plurality of nodes may be configured to: receive, from a partner merchant, a redemption transaction for a good or service and an identifier for a customer loyalty program account with the partner merchant; identify a normalized loyalty program account identifier associated with the identifier for the customer loyalty program account with the partner merchant; confirm that the normalized loyalty program account identifier is valid; send authorization for the redemption transaction to the partner merchant; receive a signed redemption transaction for the redemption transaction from the partner merchant; write the signed redemption transaction to the cryptographically-secure distributed ledger; receive, from a second node of the plurality of nodes and from a loyalty program provider, a signed publication of the signed redemption transaction; debit loyalty points for the redemption transaction from a partner merchant loyalty account maintained on the cryptographically-secure distributed ledger, wherein the partner merchant may be configured to debit the loyalty points from an account associated with the normalized loyalty program account identifier; send to a third node, instructions to credit a partner merchant cash account for the loyalty points; and send the third node instructions to debit a loyalty program provider cash account for the loyalty points.

In one embodiment, the first node may be further configured to apply a rate to covert the loyalty points to a cash amount.

In one embodiment, the rate may be dynamic.

In one embodiment, the redemption transaction may be received at an e-commerce interface for the partner merchant.

In one embodiment, the first node may identify the normalized loyalty program account identifier using a lookup on the cryptographically-secure distributed ledger.

In one embodiment, the immutable data objects comprise a balance for the customer loyalty program account, the partner merchant loyalty account, and a loyalty program provider loyalty account.

According to another embodiment, a system may include: a distributed ledger network comprising a plurality of nodes, each node comprising a computer associated with an entity and a cryptographically-secure distributed ledger storing a plurality of immutable data objects. A first node of the plurality of nodes may be configured to: receive, from a customer service interface, a loyalty point transfer request from a first customer loyalty program account to a second customer loyalty program account; identify a first normalized loyalty program account identifier associated with the first customer loyalty program account and a second normalized loyalty program account identifier associated with the second customer loyalty program account; confirm that the first normalized loyalty program account identifier and the second normalized loyalty program account identifier are valid; receive a signed transfer from the customer service interface; write the signed transfer to the cryptographically-secure distributed ledger; receive from a second node associated with a loyalty program provider, a signed publication of the signed transfer; and debit loyalty points from the first customer loyalty account, and to credit loyalty points to the second customer loyalty account.

In one embodiment, the first node may identity the first normalized loyalty program account identifier and the second normalized loyalty program account identifier using a lookup on the cryptographically-secure distributed ledger.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a distributed ledger-based loyalty reward points reconciliation platform according to an embodiment;

FIG. 2 illustrates a method for distributed ledger-based loyalty reward points earning and reconciliation according to an embodiment;

FIG. 3 illustrates a method for distributed ledger-based loyalty reward points redemption and reconciliation according to an embodiment;

FIG. 4 illustrates a method for distributed ledger-based loyalty reward points transfer and reconciliation according to an embodiment.

### DETAILED DESCRIPTION OF PREFERRED EMBODIMENTS

Embodiments are directed to loyalty reward points reconciliation platforms.

Embodiments may include a distributed ledger-supported platform that may enable multiple loyalty points/currencies to be distributed by multiple unaffiliated third-parties (e.g., partner merchants) in a transparent, automated way that facilitates adding loyalty points/miles to end customer loyalty accounts as well as settlement between the program provider and the partner merchant. This may be in exchange for some a fixed or per transaction fee for the program provider. The platform may further facilitate the “burning,” or using, of points by reversing the transaction flow and deducting points from the customer loyalty account.

In embodiments, the platform may manage a conversion rate between points or miles and dollars that may be applied during settlement. The rate may be based on, for example, business rules or priorities, and may be implemented in an automated, scalable manner.

Embodiments may provide at least some of the following technical advantages: (1) offer connectivity to one platform for all program provider/partner merchant engagement, negating the need for multiple bilateral connections; (2) offer real-time, buy-as-you go functionality, negating the need for bulk purchasing and associated balance sheet/working capital implications; (3) offer real-time business-to-business delivery versus payment, negating the need for reconciliation to achieve settlement between program providers and partner merchants; and (4) offer a shared, real-time and auditable ledger between businesses, negating reconciliation and prospective disputes.

Program providers include companies with substantial reward programs (e.g., Starbucks, Delta, etc.). Partner merchants (or “secondary's”) are smaller companies that are complimentary to and partner with the program providers. For example, for a merchant partner that is a car rental company, the program provider may be an airline. For a merchant partner that is a bookstore, the program provider may be a coffee chain.

In general, partner merchants seek to incentivize customers of a program provider to use their service or purchase their goods or services. In embodiments, the platform may connect program providers and partner merchants together through loyalty point use. For example, embodiments may facilitate the use of program provider points with any partner merchant that is partnered with the program provider.

Benefits may apply to both the program provider and the partner merchant, as the customer appreciated that he or she can spend/earn points elsewhere, and the partner merchant is likely to see an increase in business from partnering with a program provider.

Currently, when a partnership is established, the program provider sets up a bilateral API to grant the partner merchant access to make balance changes, etc. At regular intervals, such as at end of day, the partner merchant may submit a bulk buy/sell order to the program provider's API for loyalty points redeemed/earned through their service.

In the bum scenario, when a customer spends loyalty points at a partner merchant, the partner merchant account is credited and the program provider account is debited.

In one embodiment, distributed ledger technology, such as Blockchain-based technology, may be used.

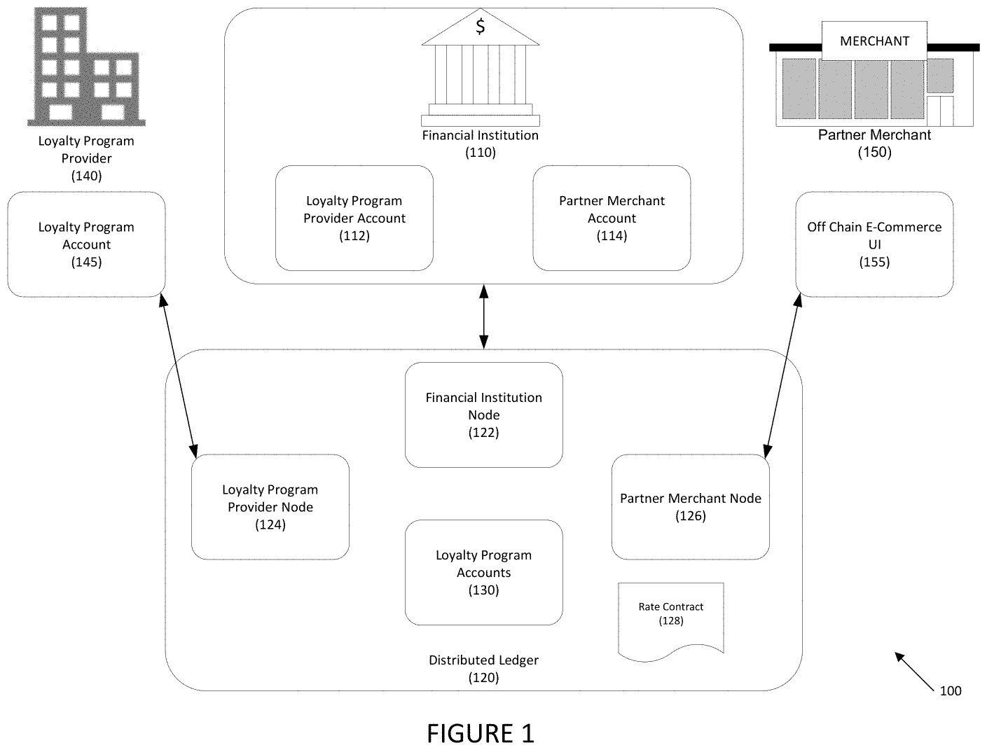

Referring to FIG. 1, a distributed ledger-based loyalty reward points reconciliation platform is disclosed according to an embodiment. System 100 may include financial institution 110, which may be a bank, a FinTech, etc. Financial institution 110 may maintain accounts for a loyalty program provider (e.g., loyalty program provider account 112) and a partner merchant (e.g., partner merchant account 114). Financial institution 110 may interface with distributed ledger 120 at financial institution node 122.

Loyalty program provider 140 may be a provider of a loyalty program, such as a points or rewards-based loyalty program. Loyalty program provider 140 may interface with distributed ledger 120 at loyalty program provider node 124. Loyalty program provider 140 may have loyalty program account 145.

Partner merchant 150 may be an entity that uses the loyalty program provided by loyalty program provider 140. Partner merchant 150 may interface with distributed ledger 120 at partner merchant node 126. Partner merchant 150 may provider off-chain e-commerce user interface (UI) 155 whereby a customer may earn or redeem points with partner merchant 150 using the loyalty program provided by loyalty program provider 140.

Distributed ledger 120 may be a cryptographically verifiable and immutable ledger that may store loyalty program interactions between loyalty program provider 140, partner merchant 150, and financial institution 110. Distributed ledger 120 may store a plurality of immutable data objects. For example, distributed ledger 120 may maintain loyalty program account 130, which may store loyalty points for a customer, a loyalty program account for partner merchant 150, and a loyalty program account for loyalty program provider 140.

Distributed ledger 120 may further maintain rate contract 128, which may specify an exchange rate for loyalty points/miles and dollars. Rate contract 128 may be dynamic and may vary depending on the partner merchant, the good or service, and the customer.

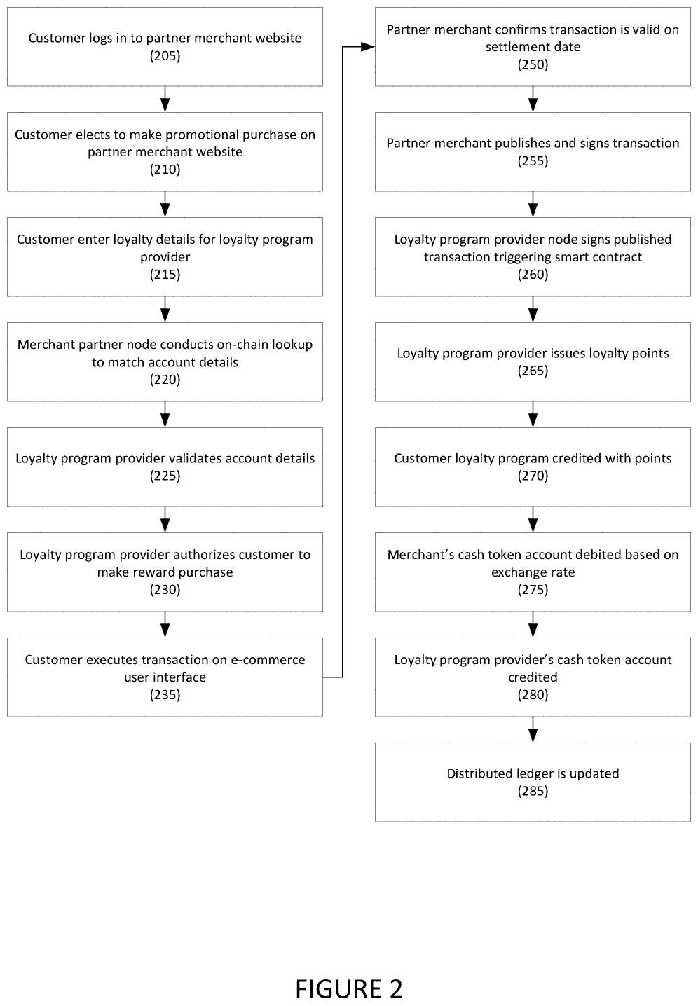

Referring to FIG. 2, a method for distributed ledger-based loyalty reward points earning and reconciliation is disclosed according to an embodiment. In FIG. 2, a customer may earn reward points from loyalty program provider while conducting a transaction with a partner merchant.

Both the program provider and partner merchant may have funded their respective accounts. For example, both the program provider and the partner merchant may fund their respective accounts (e.g., financial accounts) in a common currency (e.g., USD) to enable tokenization of cash

In addition, both the program provider and partner merchant may agree to tokenization/loyalty points exchange rates. The exchange rate may be enforceable via a foreign exchange (FX) Rate smart contract. The exchange rate may be amendable with authorization to amend given by multi-signature authentication from both parties.

In step 205, a customer may login to a partner merchant website, and, in step 210, the customer may select a good or service to purchase in order to earn loyalty program points. In one embodiment, the partner merchant may provide an off-chain ecommerce user interface.

In step 215, the customer may enter information for the customer's account with the loyalty program provider, or for the partner merchant. For example, the customer may enter an identifier for a loyalty account with the loyalty program provider or with the partner merchant.

In one embodiment, the customer may provide the customer's account with the loyalty program provider as a payment method with the partner merchant, such as in the customer's digital wallet, as a partner-merchant specific token, etc.

In step 220, the merchant partner node on the distributed ledger may conduct an on-chain lookup to match the customer's loyalty account information. In one embodiment, a smart contract on the merchant partner node may retrieve a normalized loyalty account number associated with the account identifier received from the customer.

In step 225, the account details may be validated by the loyalty program provider. For example, the loyalty program provider may confirm that the normalized loyalty account number is valid and the account is in good standing (e.g., has not expired), that the good or service is approved for loyalty point earning, etc.

In step 230, the customer may be authorized to conduct the reward-earning purchase, and in step 235, the customer may execute the transaction on an e-commerce user interface that may be provided by the partner merchant.

At a settlement date or time agreed to by the program provider and the partner merchant, in step 250, the partner merchant may confirm that the transaction is valid. For example, the partner merchant may confirm that the good or service was purchased and that the good or service is eligible to earn loyalty points.

In step 255, the partner merchant node may publish and sign the transaction. For example, the partner merchant node may write the signed transaction to the distributed ledger.

In step 260, the loyalty program provider node may sign the published transaction, triggering a smart contract. In on embodiment, the loyalty program provider node may monitor the distributed ledger for relevant entries.

In step 265, the loyalty program provider may issue loyalty points. In one embodiment, the loyalty program provider may credit the customer loyalty account on the distributed ledger based on the purchase of a qualifying good or service.

In step 270, the customer loyalty program account is credited with points, and in step 275, the partner merchant's cash token account is debited an amount based on the exchange rate. In step 280, the loyalty program provider's cash token account is credited by the amount.

In step 285, the accounts on the distributed ledger are updated.

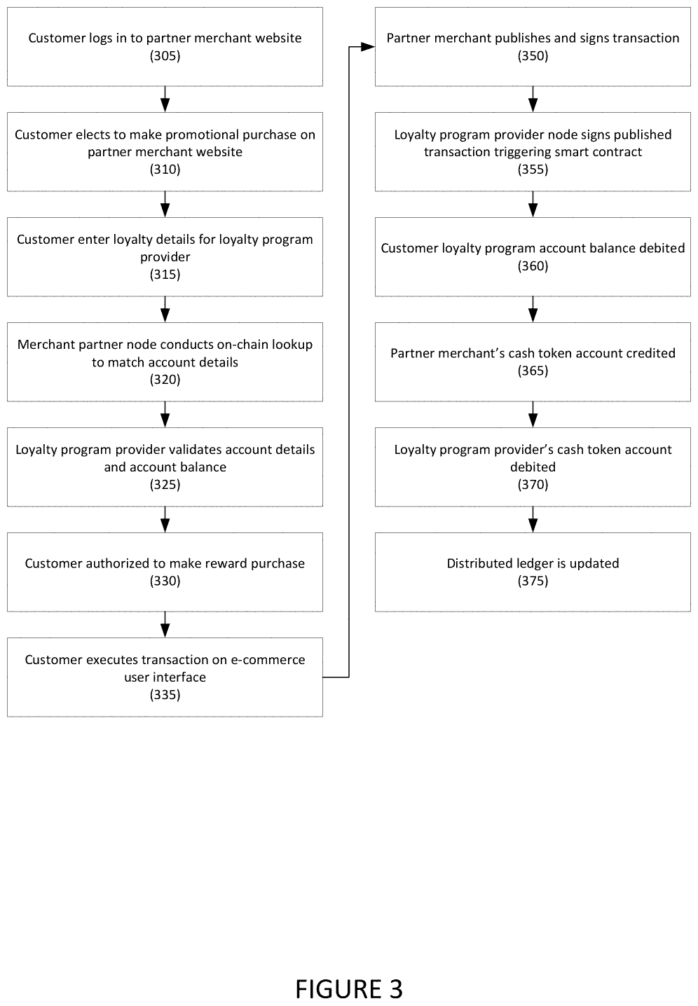

Referring to FIG. 3, a method for distributed ledger-based loyalty reward points redemption and reconciliation is disclosed according to an embodiment. In FIG. 3, a customer may bum reward points from a program provider with a partner merchant. Both the program provider and partner merchant may have funded their respective accounts. For example, both the program provider and the partner merchant may fund their respective accounts, such as International Demand Deposit Account (iDDA) accounts in a common currency (e.g., USD) to enable tokenization of cash as necessary and/or desired.

In addition, both the program provider and partner merchant agree to tokenization/loyalty points exchange rates. The exchange rate may be enforceable via a foreign exchange (FX) rate smart contract. The exchange rate may be amendable with authorization to amend given by multi-signature authentication from both parties.

In step 305, a customer may login to a partner merchant website, and, in step 310, the customer may select a good or service to purchase with loyalty program points. In one embodiment, the partner merchant may provide an off-chain ecommerce user interface.

In step 315, the customer may enter information for the customer's account with the loyalty program provider.

In step 320, the merchant partner node on the distributed ledger may conduct an on-chain lookup to match the customer's loyalty account information. In one embodiment, a smart contract on the merchant partner node may retrieve a normalized loyalty account number associated with the account identifier received from the customer.

In step 325, the account details may be validated by the loyalty program provider. For example, the loyalty program provider may confirm that the customer's account number is valid, that the good or service is approved for earning, etc.

In one embodiment, the merchant partner may confirm that the customer has sufficient loyalty points available before presenting the customer with an option to redeem loyalty points.

In step 330, the customer may be authorized to conduct the reward-redeeming purchase, and in step 335, the customer may execute the transaction on an e-commerce user interface that may be provided by the partner merchant.

On a settlement date agreed to by the program provider and the partner merchant, in step 350, the partner merchant may publish and sign the transaction. For example, the partner merchant node may write the signed transaction to the distributed ledger.

In step 355, the loyalty program provider node may sign the published transaction, triggering a smart contract. In on embodiment, the loyalty program provider node may monitor the distributed ledger for relevant entries.

In step 360, the customer loyalty program account balance is debited at program provider's proprietary system.

In step 365, the partner merchant's cash token account is credited, and in step 370, the program provider's cash token account is debited. In step 375, the distributed ledger may be updated.

In one embodiment, the customer may instruct loyalty program points to be transferred to another customer. A first customer may interface with an interface at a node, such as the partner merchant node, the loyalty program provider node, a customer service node, etc., and may indicate a desire to transfer the points to a second customer. The first customer may identify the second customer to the interface, and the node may treat the transfer as a redemption transaction by the first customer, and an earning transaction by the second customer.

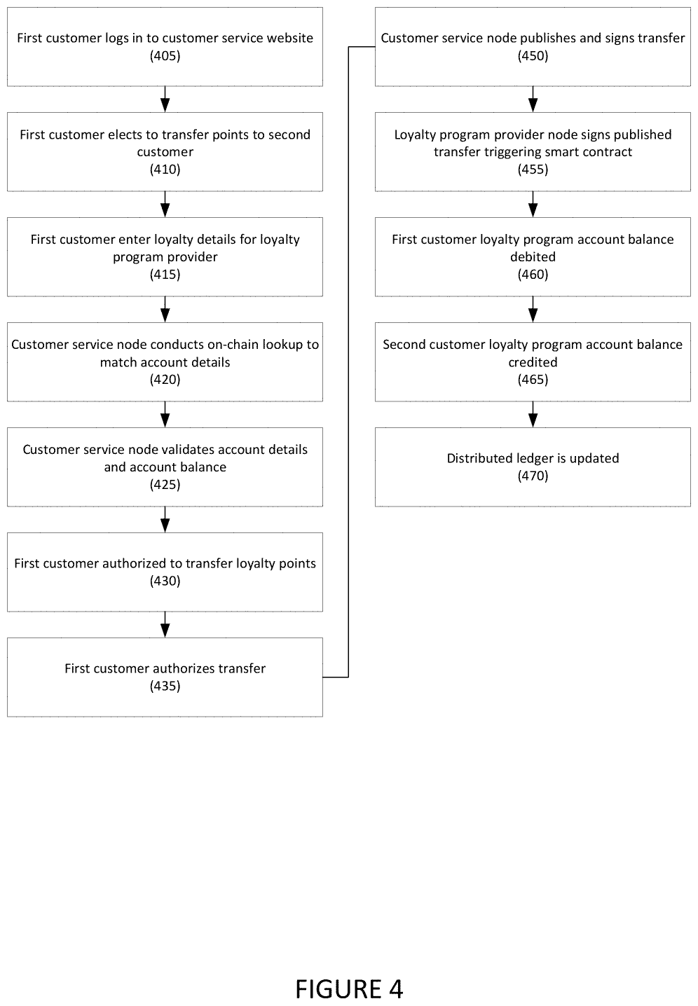

Referring to FIG. 4, a method for distributed ledger-based loyalty reward points transfer and reconciliation is disclosed according to an embodiment.

On the trade date, in step 405, a first customer may login to a website, such as a customer service website at a customer service node, a loyalty provider node, etc., and, in step 410, the customer may elect to transfer loyalty points to a second customer. In one embodiment, the loyalty program provider may provide a customer service user interface.

In step 415, the first customer may enter information for the first customer's account with the loyalty program provider and the second customer's account with the loyalty program provider.

In step 420, the customer service node on the distributed ledger may conduct an on-chain lookup to match the first customer's loyalty account information and the second customer's loyalty account information. In one embodiment, a smart contract on the customer node may retrieve a normalized loyalty account numbers associated with the account identifiers received from the first customer.

In step 425, the account details may be validated by the loyalty program provider. For example, the loyalty program provider may confirm that the first customer's account number is valid and has sufficient loyalty points available before presenting the customer with an option to redeem loyalty points. It may further confirm that the second customer's account is valid.

In step 430, the first customer may be authorized to transfer the loyalty points to the second customer, and in step 435, the first customer may execute the transfer.

In step 450, the customer service node may publish and sign the transfer. For example, the customer service node may write the signed transfer to the distributed ledger.

In step 455, the loyalty program provider node may sign the published transfer, triggering a smart contract. In on embodiment, the loyalty program provider node may monitor the distributed ledger for relevant entries.

In step 460, the first customer loyalty program account balance is debited, and, in step 465, the second customer loyalty program account balance is credited. This may be by the loyalty program provider's proprietary system.

In step 470, the accounts on the distributed ledger may be updated.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A system, comprising:
a distributed ledger network comprising:
a plurality of nodes, each node comprising a computer associated with an entity; and
a cryptographically-secure distributed ledger storing a plurality of immutable data objects;
wherein:
a first node of the plurality of nodes is configured to receive, from a partner merchant, a purchase transaction for a good or service and an identifier for a customer loyalty program account with the partner merchant;
the first node is configured to identify a normalized loyalty program account identifier associated with the identifier for the customer loyalty program account with the partner merchant;
the first node is configured to confirm that the normalized loyalty program account identifier is valid;
the first node is configured to send authorization for the purchase transaction to the partner merchant;
the first node is configured to receive a signed purchase transaction for the purchase transaction from the partner merchant;
the first node is configured to write the signed purchase transaction to the cryptographically-secure distributed ledger;
the first node is configured to receive, from a second node of the plurality of nodes and from a loyalty program provider, a signed publication of the signed purchase transaction;
the first node is configured to issue loyalty points for the purchase transaction to a partner merchant loyalty account maintained on the cryptographically-secure distributed ledger, wherein the partner merchant is configured to issue the loyalty points to an account associated with the normalized loyalty program account identifier;
the first node is configured to send to a third node of the plurality of nodes, instructions to debit a partner merchant cash account for the loyalty points; and
the first node is configured to send the third node instructions to credit a loyalty program provider cash account for the loyalty points.

2. The system of claim 1, wherein the first node is further configured to apply a rate to covert the loyalty points to a cash amount.

3. The system of claim 2, wherein the rate is dynamic.

4. The system of claim 1, wherein the purchase transaction is received at an e-commerce interface for the partner merchant.

5. The system of claim 1, wherein the first node identifies the normalized loyalty program account identifier using a lookup on the cryptographically-secure distributed ledger.

6. The system of claim 1, wherein the immutable data objects comprise a balance for the customer loyalty program account, the partner merchant loyalty account, and a loyalty program provider loyalty account.

7. A system, comprising:
a distributed ledger network comprising:
a plurality of nodes, each node comprising a computer associated with an entity; and
a cryptographically-secure distributed ledger storing a plurality of immutable data objects;
wherein:
a first node of the plurality of nodes is configured to receive, from a partner merchant, a redemption transaction for a good or service and an identifier for a customer loyalty program account with the partner merchant;
the first node is configured to identify a normalized loyalty program account identifier associated with the identifier for the customer loyalty program account with the partner merchant;
the first node is configured to confirm that the normalized loyalty program account identifier is valid;
the first node is configured to send authorization for the redemption transaction to the partner merchant;
the first node is configured to receive a signed redemption transaction for the redemption transaction from the partner merchant;
the first node is configured to write the signed redemption transaction to the cryptographically-secure distributed ledger;
the first node is configured to receive, from a second node of the plurality of nodes and from a loyalty program provider, a signed publication of the signed redemption transaction;
the first node is configured to debit loyalty points for the redemption transaction from a partner merchant loyalty account maintained on the cryptographically-secure distributed ledger, wherein the partner merchant is configured to debit the loyalty points from an account associated with the normalized loyalty program account identifier;
the first node is configured to send to a third node, instructions to credit a partner merchant cash account for the loyalty points; and
the first node is configured to send the third node instructions to debit a loyalty program provider cash account for the loyalty points.

8. The system of claim 7, wherein the first node is further configured to apply a rate to covert the loyalty points to a cash amount.

9. The system of claim 8, wherein the rate is dynamic.

10. The system of claim 7, wherein the redemption transaction is received at an e-commerce interface for the partner merchant.

11. The system of claim 7, wherein the first node identifies the normalized loyalty program account identifier using a lookup on the cryptographically-secure distributed ledger.

12. The system of claim 7, wherein the immutable data objects comprise a balance for the customer loyalty program account, the partner merchant loyalty account, and a loyalty program provider loyalty account.

13. A system, comprising:
a distributed ledger network comprising:
a plurality of nodes, each node comprising a computer associated with an entity; and
a cryptographically-secure distributed ledger storing a plurality of immutable data objects;
wherein:
a first node of the plurality of nodes is configured to receive, from a customer service interface, a loyalty point transfer request from a first customer loyalty program account to a second customer loyalty program account;
the first node is configured to identify a first normalized loyalty program account identifier associated with the first customer loyalty program account and a second normalized loyalty program account identifier associated with the second customer loyalty program account;
the first node is configured to confirm that the first normalized loyalty program account identifier and the second normalized loyalty program account identifier are valid;
the first node is configured to receive a signed transfer from the customer service interface;
the first node is configured to write the signed transfer to the cryptographically-secure distributed ledger;
the first node is configured to receive from a second node associated with a loyalty program provider, a signed publication of the signed transfer; and
the first node is configured to debit loyalty points from the first customer loyalty account, and to credit loyalty points to the second customer loyalty account.

14. The system of claim 13, wherein the first node identifies the first normalized loyalty program account identifier and the second normalized loyalty program account identifier using a lookup on the cryptographically-secure distributed ledger.
